(19) United States
(12) Patent Application Publication
(10) Pub. No.: US 2018/0361476 A1
(43) Pub. Date: Dec. 20, 2018

(54) DESIGNING AND MANUFACTURING METHOD FOR POWDER INJECTION MOLDING PISTON RING

(71) Applicant: Ruo Huang, Beijing (CN)

(72) Inventor: Ruo Huang, Beijing (CN)

(21) Appl. No.: 15/563,790

(22) PCT Filed: Aug. 5, 2016
(86) PCT No.: PCT/CN2016/093460

§ 371 Date: Dec. 12, 2017

(30) Foreign Application Priority Data
Aug. 7, 2015 (CN) 201510478187.0

(51) Int. Cl. B22F 3/22; B22F 5/02

(52) U.S. Cl. CPC B22F 3/225; F16J 9/26; B22F 5/02

(57) ABSTRACT

A designing and manufacturing method for powder injection molding a piston ring comprises the following steps: (a) designing an elliptical equation of the piston ring according to the technical requirements of the piston ring product and providing the free opening gap size; (b) conducting engineering analysis on structural strength, stress-strain, and friction and wear by means of a computer; (c) designing and selecting a powder material, designing a proportion ratio of powder and adhesive, and manufacturing a feeding material for injection by means of mixing and granulating; (d) designing and manufacturing an injection mold for the elliptical piston ring; (e) manufacturing a three-dimensional elliptical piston ring blank by injecting, degreasing, sintering and post-processing; (f) cutting an opening; and (g) inspecting translucency, elasticity and size of the product, then packaging and delivering or warehousing. The present designing and manufacturing method employs the technique of powder injection molding and computer-aided design and engineering analysis, designs and selects powder materials, and designs a proportion ratio of powder and adhesive; due to feeding particles being uniform, the piston ring structure is more uniform, and has improvements over the traditional casting process with more design freedom.

### CROSS-REFERENCE TO RELATED APPLICATIONS

The present application is a national phase of PCT/CN2016/093460, filed Aug. 5, 2016, which claimed priority to China application No. 201510478187.0, filed Aug. 7, 2015. The contents of these applications are incorporated hereby by reference.

### TECHNICAL FIELD

The present invention relates to the field of internal combustion engine, turbocharger, reciprocating machine and general mechanical sealing technology, particularly, involved a designing and manufacturing method for powder injection molding piston rings.

### BACKGROUND OF THE INVENTION

Piston ring is the key part of internal combustion engine and reciprocating machinery such as compressor, which works in a bad condition. Generally, piston rings of internal combustion engine are divided into compression rings and oil rings. Compression rings, which mainly seal gas and lubricating oil and contact with high temperature combustion gas directly, form the most important friction pair of internal combustion engine together with cylinder liner under high temperature and pressure, doing reciprocating friction motion, and have important effect on thermal aerodynamic performance and reliability of internal combustion engine. Therefore, the material, shape and dimensional precision requirements of compression rings are very strict. Oil rings mainly prevent lubricating oil from leakage and work in a lower temperature. Piston rings are commonly referred as sealing rings when applied to the turbocharger. Sealing ring is one of the most important parts of turbocharger, swelling tightly in the sealing groove by its own elasticity. At the turbine end, sealing ring seals the high temperature gas on one side and seals lubricating oil on the other side, and moves axially with the axial movement of rotor shaft in the meantime. On this occasion the seal ring is easy to lose elasticity wear excessively or corrode, resulting in sealing ability loss and the leakage of air and oil, which directly influences the reliability of the supercharger. For this reason, designing and manufacturing piston rings(sealing ring, hereinafter referred to as piston ring) having high requirements like high temperature resistance, high frictional resistance and corrosion resistance, such as compression ring in internal combustion engine and sealing ring at the turbine end of turbocharger with excellent performance, has always been the goal of piston ring industry. The oil rings of internal combustion engine and sealing rings of turbocharger compressor are mainly manufactured by steel band coiling method. While the compression rings of the internal combustion engine and sealing rings of turbocharger turbine end are usually manufactured by “casting+machining” method. There are two specific methods:

(1) Circle Method (heat setting method): Generally it adopts the Centrifugal Casting process: casting cylindrical single-piece, double-piece or multiple-piece piston ring blanks and then cutting the blanks into single rings and mill openings on the ordinary lathe; secondly, processing regular lathing, milling, internal and external grinding, and processing heat treatments such as heat stabilizing, heat styling, thermal fixing, etc. The piston ring manufactured should have opening size meeting the requirement and designed elastic force on operating state (circle). Besides, the entire process should make sure that the piston ring can fit integrally with cylinder wall to serve sealing function and has lower resistance and wear in friction pair formed with cylinder wall to improve the mechanical efficiency. The basic idea of Circle Method is that the machining processes should be carried out under the state of “circle”, therefore all the machining equipment for lathing, milling, grinding is ordinary equipment, and the elasticity of piston ring mainly comes from heat treatment process.

(2) Ellipse method (Copying, Exploratory method): Generally it adopts the Centrifugal Casting process: casting a cylindrical single-piece, double-piece or multiple-piece piston ring blanks, and then cutting the blanks into single rings and mill openings on the ordinary lathe; then processing copying cutting on ordinary lathe or grinder, or processing “Copying Ellipse” machining on the copying lathe and copying grinder, during which the ring gap can keep the size in free state and the piston ring can retain an elliptical shape; finally, just one heat treatment process will be enough. The basic idea of the elliptical method is to keep the “elliptical” state in the machining process, which can reduce the steps of heat treatment process and make the dimensional precision easier to control. However, this method requires special equipment or “copying explorator” equipment. Centrifugal Casting method is generally used for the cylindrical blanks of piston ring with relative large size (such as diameter bigger than 100 mm). Piston ring of turbocharger is basically less than 50 mm, which is often manufactured by Circle Method after cutting the cylindrical rod formed by pouring into plates.

As is known to all, traditional “casting+machining” process has the following problems:

The cylindrical blank manufactured by casting still inevitably has defects such as segregation, pores, shrinkage and sand blister after machining.

The utilization rate of materials is low. Generally, in the entire manufacturing process, the utilization rate of casting material is less than 50%, and the material utilization rate during sand mold casting is even below 30%.

The elliptical piston rings require various copying machines (lathe, grinder) and explorator, which results in low production efficiency and high manufacturing cost.

For piston ring blank with diameter less than 50 mm, it is suitable to be manufactured by molding casting instead of Centrifugal Casting.

To solve the problems above, people have been trying to discover new manufacturing techniques and new materials. The patent “2004100377023—Powdered metallurgical piston ring and process for production thereof” adopts traditional pressure molding (PM) of powder metallurgy to produce iron-base powder piston rings and provides the composition of the components. In this way, some machining processes can be cut out and the performance is expected to improve. However, PM of powder metallurgy costs more than casting, the total cost is not decreased obviously and manufacturing piston rings by PM is also difficult to be largely popularized.

### CONTENTS OF THE INVENTION

In response to the existing problems in production of the piston rings mentioned above, the present invention provides a designing and manufacturing method for powder injection molding piston rings, which can greatly improve the material utilization ratio, product performance and production efficiency. This method allows designing piston rings with a complex three-dimensional shape and an elliptical shape in the free state. The piston ring is formed directly by powder injection molding without dedicated devices or “profiling explorator” equipment. Besides, heat treatment is not necessary generally, piston ring with uniform microstructure and high precision can be manufactured only through slight grinding process.

The technical solution to solve the problems in the present invention is: A designing and manufacturing method for powder injection molding piston rings, which comprises the following steps:
(1) Designing an elliptical equation of the piston ring according to the technical requirements of the piston ring product and providing the free opening gap size;
(2) Conducting engineering analysis on structural strength, stress-strain, and friction and wear by means of a computer;
(3) Designing and selecting a powder material, designing a proportion ratio of powder and adhesive, and manufacturing a feeding material for injection by means of mixing and granulating;
(4) Designing and manufacturing an injection mold for the elliptical piston ring;
(5) Manufacturing a three-dimensional elliptical piston ring blank by injecting, degreasing, sintering and post-processing;
(6) Machining: cutting an opening, grinding the outer surface by Circle Method and double-side grinding both ends of the elliptical piston ring; then determining whether heat treatment is required to make cutting process convenient or meet the demand of surface hardness according to the mechanical properties of materials
(7) Inspecting translucency, elasticity and size of the product, then packaging and delivering or warehousing.

The above-mentioned elliptical piston ring is a piston ring which is perfect circle in operating state and three dimensional ellipse in free state. The cross section of the piston ring is rectangular, conical, trapezoid, torsional or grooved.

The post-treatment mainly refers to shot blasting treatment, polishing treatment and shaping.

The difference between the present invention and the prior technology is as following:
1. Different design of product—Restricted by production technology, the product structure is simple designed through the traditional process, and the cost will be high in order to improve the performance and the complexity of the products. According to the PIM technology, mold filling can be achieved by flowing feeding material, which highly liberalizes the design and manufacture of mold. PIM technology brings about great changes to product design. The design form is no longer in the control of technological process, and has a high degree of freedom, which means it is possible to try various forms of design to improve the performance of piston ring;
2. Different raw materials—The material of piston ring manufactured by traditional process is mainly cast iron and steel, and the material of turbocharger piston ring is mainly Cr—Mo alloy and alloy steel. Raw material in powder injection molding technology is feeding material consisting of powder and binder, so, in theory, all the materials that can be made into powder are able to become the raw materials of PIM technology, which greatly broadens the selectable range of material, especially the select of the special ceramic piston rings and composite piston rings. Because the ceramic material is difficult to be machined, we can manufacture ceramic piston rings by powder injection molding in the permissive process precision tolerance range, in other words, the precision of piston ring made by PIM method can be guaranteed without machining, which makes the advantage more obvious—the precision of blank manufactured by PIM is the highest among existing machining technologies (higher than precise casting, traditional pressure molding of powder metallurgy, precision die forging etc.).
3. Metal mold used in powder injection molding has life equivalent to engineering plastic injection mold, which can be used hundreds of thousands of times. This guarantees the consistency and repeatability of product, greatly improves production efficiency and reduces production cost;
4. Different forming process (the main difference from the traditional casting process)—The existing methods mainly use the casting process, which has inherent defects including shrinkage, porosity, segregation and etc. inevitably. PIM process is a forming process of pressure fluid. The existence of binder guarantees uniform distribution of powder and thus eliminate in homogeneity of blank microstructure, and then the sintered density can reach its material's theoretical density. Higher density means better strength and toughness which will significantly enhances the abrasion resistance performance of piston rings.
5. Powder injection molding is especially suitable for small size (the size is less than 200 mm and the weight is less than 500 g) and highly complex structure (especially complex 3D surface, special structure, etc.) parts. Using injection machine to manufacture blank guarantees the mold cavity is fully filled with material, which means the realization of highly complex structure manufacture is also guaranteed. Therefore, PIM technology has unique advantages in manufacturing complex products. The piston ring has relatively small size and a complex curved working face (possibly non two elliptical curve), which is hard to be manufactured by traditional technology with low rate of finished products yield and poor precision.
6. Different subsequent process. Injection molding blank has high precision and generally maintains dimensional tolerance around ±0.1%˜±0.3%, which means the product shape is close to or already reaches the final product requirements and basically has no need for secondary processing or only a little finish machining. Therefore, the subsequent processing step is greatly simplified and PIM is particularly suitable for manufacturing parts that are difficult or unable to be machined.

### ADVANTAGES OF THE PRESENT INVENTION

Compared to existing technology, present invention has following advantages:

The invention improves the performance of the existing piston ring and meets higher technical requirements by changing the material and manufacturing technology.

Greatly improve the utilization ratio of material to generally more than 95%, while the material utilization rate of traditional casting process is only about 30%.

The slight finish machining required by piston ring manufactured by PIM is far less than that by traditional process, which reduces the steps of process, raises the production efficiency, and lower the cost.

Easy to adjust the radial elasticity to meet the requirements of the internal combustion engine, so that the friction and wear between the piston ring and cylinder liner can be reduced. And the reliability and life of the internal combustion engine can be improved.

The speed during Centrifugal casting has great influence on performance. If the speed is too high, the crack may appear on the casting surface; if the speed is too small, the forming of blank cannot be guaranteed and problems like segregation are likely to arise. Due to well-distributed feeding material particles, the microstructure of piston ring is more uniform, which makes up the defects of traditional casting process, improves the free degree of piston ring design and the structure of piston ring.

### BRIEF DESCRIPTION OF THE DRAWINGS

FIG. 1 is the form of an oval piston ring in operation,

FIG. 2 is the form of an oval piston ring in free state,

FIG. 3 is a flow chart of piston ring produced by powder injection molding.

In the figure, 1, inner hole 2, outer surface 3, hatch 4, inner surface.

### DESCRIPTION OF THE PREFERRED EMBODIMENTS

In order to make the technical proposal of the present invention better understood by the technicians in the field. The present invention will be described below in greater detail based on an example, with reference to the appended drawings.

A designing and manufacturing method for powder injection molding piston rings, which comprises the following steps:

(1) Product design: designing a three-dimensional elliptical equation and free opening gap size (such as 3, 3.5, 4, 4.5, 5 mm) of the three-dimensional elliptical piston rings according to the technical requirements of the piston ring product as well as injection mold;

(2) Computer aided engineer analysis: conducting engineering analysis on structural strength, stress-strain, and friction and wear by means of a computer;

(3) Select or design the material: selecting Fe base powder (such as sintered carbon steel F0112J, GB/T14667.1-93, with carbon content 0.4%˜0.7%, others less than 1.5%, and Fe for the rest) as material of 3D elliptical piston ring, and particle size is 10˜50 μm; the material could also be Ni-base powder (such as IN100) or stainless steel-base powder (such as 1Cr13, 2Cr13 and 316L).

(4) Manufacture of feeding material: determining the weight ratio of Fe-base powder and binder (consisting of paraffin, HDPE, polypropylene and so on) according to elliptical piston ring material, and then manufacturing feeding material through mixing and prilling; the above weight ratio is 80 wt %˜85 wt % Fe-base powder and 15 wt %˜20 wt % binder.

(5) Regular powder injection molding process: manufacturing a three-dimensional elliptical piston ring blank by injecting, degreasing, sintering and post-processing.

(6) Machining: cutting an opening, grinding the outer surface by Circle Method and double-side grinding both ends of the elliptical piston ring.

(7) Inspecting translucency, elasticity and size of the product such as free opening gap size, then packaging and delivering or warehousing.

The mentioned mixing, injecting, degreasing and sintering refer to followings respectively:

a) Mixing: blending 80 wt %˜85 wt % Fe-base powder and 15 wt %˜20 wt % bonder made of paraffin, HDPE, polypropylene and stearic acid in a mixer at temperature of 150˜200° C. and speed of 30˜45 rpm for 30˜60 min to manufacture feeding material.

b) Injecting: forming the feeding material in a mold pressing machine for plastic at the temperature of 150˜200° C. and pressure of 20˜200 MPa, and then getting the blank of elliptical piston ring.

c) Degreasing: dipping the blank in organic solvent at temperature of 40˜60° C. for 2˜4 h; And after drying, thermal degreasing at 200˜600° C. for 6˜8 h with protection of decomposed ammonia.

d) Sintering: putting the degreased blank into vacuum sintering furnace at temperature of 1300˜1850° C. for 20˜60 min, and then getting piston rings that meet the demand of shape and dimensional precision.

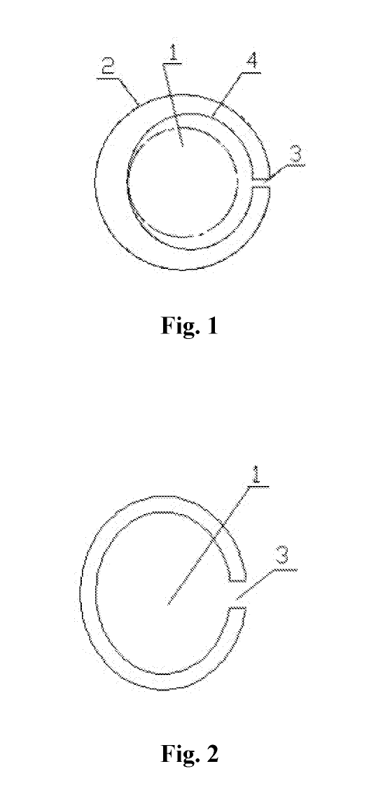

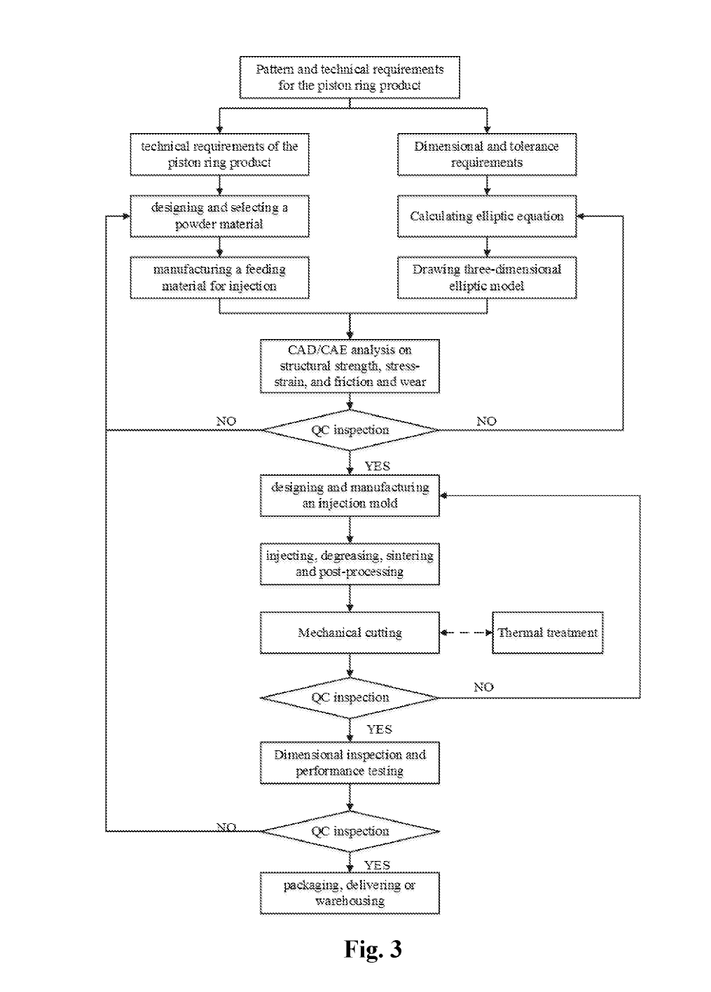

FIG. 1 shows a piston ring under the operating state. The outer surface of the mentioned piston is a circle and the inside surface is elliptical. FIG. 2 shows a piston ring under free state. Both the outer and inside surface is elliptical and the opening gap size is larger than that under operating state. FIG. 3 shows the flow chart of piston ring produced by powder injection molding in present invention.

Although some examples of methods have been illustrated in the accompanying Drawings and described in the foregoing DESCRIPTION OF THE PREFERRED EMBODIMENTS, it will be understood that the example embodiments disclosed are not limiting, but are capable of numerous rearrangements, modifications and substitutions.

1. A designing and manufacturing method for powder injection molding piston rings, which comprises the following steps:
(1) Designing an elliptical equation of the piston rings according to the technical requirements of the piston ring product and providing the free opening gap size;
(2) Conducting engineering analysis on structural strength, stress-strain, and friction and wear by means of a computer;
(3) Designing and selecting a powder material, designing a proportion ratio of powder and adhesive, and manufacturing a feeding material for injection by means of mixing and granulating;
(4) Designing and manufacturing an injection mold for the elliptical piston ring;
(5) Manufacturing a three-dimensional elliptical piston ring blank by injecting, degreasing, sintering and post-processing;
(6) Machining: cutting an opening, grinding the outer surface by Circle Method and double-side grinding both ends of the elliptical piston ring; then determining whether heat treatment is required to make cutting process convenient or meet the demand of surface hardness according to the mechanical properties of materials;
(7) Inspecting translucency elasticity and size of the product, then packaging and delivering or warehousing.
